(19) United States
(12) Patent Application Publication
(10) Pub. No.: US 2015/0125133 A1
(43) Pub. Date: May 7, 2015

(54) METHOD FOR TRANSCODING MULTIMEDIA, AND HADOOP-BASED MULTIMEDIA TRANSCODING SYSTEM FOR PERFORMING THE METHOD

(71) Applicant: Konkuk University Industrial Cooperation Corp., Seoul (KR)

(72) Inventors: Myoung Jin KIM, Seoul (KR); Yun CUI, Seoul (KR); Han Ku LEE, Seoul (KR); Seung Ho HAN, Cheonan-si (KR)

(73) Assignee: KONKUK UNIVERSITY INDUSTRIAL COOPERATION CORP., Seoul (KR)

(21) Appl. No.: 14/092,852

(22) Filed: Nov. 27, 2013

(30) Foreign Application Priority Data
Nov. 6, 2013 (KR) 10-2013-0134056

(51) Int. Cl. G11B 27/10; H04N 19/40

(52) U.S. Cl. CPC G11B 27/10; H04N 19/40
USPC 386/326

(57) ABSTRACT

A multimedia transcoding method and a system for performing the multimedia transcoding are provided. A hadoop-based multimedia transcoding system may include a video and image data collection domain (VIDCD) to collect original encoded media data sets, and to store the collected original encoded media data sets, a hadoop distributed file system (HDFS)-based splitting and merging domain (HbSMD) to split the original encoded media data sets into first blocks, and to automatically distribute the first blocks to a plurality of data nodes of an HDFS, by using the HDFS, and a MapReduce-based transcoding domain (MbTD) to transcode second blocks distributed to the plurality of data nodes, through distributed and parallel processing, using a MapReduce framework.

### CROSS-REFERENCE TO RELATED APPLICATION

This application claims the benefit of Korean Patent Application No. 10-2013-0134056, filed on Nov. 6, 2013, in the Korean Intellectual Property Office, the disclosure of which is incorporated herein by reference.

### BACKGROUND

1. Field of the Invention

The present invention relates to a multimedia transcoding method and a hadoop-based multimedia transcoding system for performing the multimedia transcoding method.

2. Description of the Related Art

A social media cloud computing service environment (SMCCSE) refers to a service model using cloud computing to support social networking services (SNSs), such as Twitter, Facebook, and the like, social media services, such as YouTube, and the like, and social game services, such as a social network game of Facebook, and the like.

The SMCCSE may include software as a service (SaaS), a platform as a service (PaaS), and an infrastructure as a service (IaaS). To develop an SNS, the SaaS may provide a social media application program interface (API), a web-based social software development kit (SDK), and a service delivery platform. The IaaS may provide a virtualization environment for building computing resources, such as a server, a storage, and the like. The PaaS may provide a distributed and parallel processing system for a multimedia transcoding function. The PaaS may include a social media data analysis platform used to analyze data, a cloud distributed and parallel data processing platform used to store, distribute and process social media data, for example an audio format, a video format, and an image format, and a cloud infra management platform used to manage and monitor computing resources.

To reduce a processing time and maintenance costs required to build a computing resource infrastructure, multimedia transcoding may be performed using a distributed and cluster-based scheme. The multimedia transcoding may procure computing resources for a transcoding process by simply increasing a number of clusters.

### SUMMARY

An aspect of the present invention provides a technology for guaranteeing stability of data and a system by splitting collected multimedia data with large capacity into blocks of a predetermined size, by replicating the blocks, and storing block replicas in a hadoop distributed file system (HDFS) of each data node.

Another aspect of the present invention provides a technology for significantly reducing a transcoding processing time by quickly performing distributed and parallel processing of data blocks distributed to an HDFS of each data node.

According to an aspect of the present invention, there is provided a hadoop-based multimedia transcoding system, including: a video and image data collection domain (VIDCD) to collect original encoded media data sets, and to store the collected original encoded media data sets; a hadoop distributed file system (HDFS)-based splitting and merging domain (HbSMD) to split the original encoded media data sets into first blocks, and to automatically distribute the first blocks to a plurality of data nodes of an HDFS, by using the HDFS; and a MapReduce-based transcoding domain (MbTD) to transcode second blocks distributed to the plurality of data nodes, through distributed and parallel processing, using a MapReduce framework.

The HbSMD may merge blocks that are transcoded and transmitted by the MbTD, and may generate transcoded media data sets.

The HbSMD may distribute each of the first blocks to at least two data nodes among the plurality of data nodes, by replicating each of the first blocks.

The MbTD may include a plurality of transcoders respectively corresponding to the plurality of data nodes. Each of the plurality of transcoders may include an InputFormat to read blocks distributed to a corresponding data node in a byte stream form, and to generate a line record of an input key/input value pair, a mapper to process the line record of the input key/input value pair, and to generate a line record of an output key/output value pair, and an OutputFormat to transmit the line record of the output key/output value pair to the corresponding data node.

Each of the first blocks may be set to have a default block size.

Setting of a number of block replicas obtained by replicating each of the first blocks may be enabled.

The hadoop-based multimedia transcoding system may further include a cloud-based infrastructure domain (CbID) to provide a configuration environment of the HDFS and the MapReduce framework.

The VIDCD may collect the original encoded media data sets, based on a data set size and an acquisition time.

Each of the input key/input value pair and the output key/output value pair may include a file name and a single byte stream.

The InputFormat may provide information regarding a number of map tasks for the MapReduce framework.

The map tasks may be prescheduled in the MapReduce framework.

The mapper may perform distributed and parallel processing of the line record of the input key/input value pair, through a map function.

According to another aspect of the present invention, there is provided a multimedia transcoding method, including: collecting original encoded media data sets, and storing the collected original encoded media data sets; splitting the original encoded media data sets into first blocks, and automatically distributing the first blocks to a plurality of data nodes; and transcoding second blocks distributed to the plurality of data nodes, through distributed and parallel processing.

The multimedia transcoding method may further include merging transcoded blocks, and generating transcoded media data sets corresponding to the original encoded media data sets.

The splitting may include distributing each of the first blocks to at least two data nodes among the plurality of data nodes, by replicating each of the first blocks.

The transcoding may include reading blocks distributed to the plurality of data nodes in a byte stream form, and generating a line record of an input key/input value pair, processing the line record of the input key/input value pair, and generating a line record of an output key/output value pair, and transmitting the line record of the output key/output value pair.

The processing may include performing distributed and parallel processing of the line record of the input key/input value pair, through a map function.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a hadoop-based multimedia transcoding system according to an embodiment of the present invention;

FIG. 2 is a diagram illustrating a configuration of each of a plurality of transcoders of FIG. 1;

FIGS. 3A through 3D are diagrams illustrating classes included in an InputFormat of FIG. 2;

FIGS. 4A and 4B are diagram illustrating classes that are associated with image conversion and that are included in a mapper of FIG. 2;

FIGS. 5A through 5D are diagrams illustrating classes that are associated with video conversion and that are included in the mapper of FIG. 2;

FIGS. 6A through 6D are diagrams illustrating classes included in an OutputFormat of FIG. 2; and

FIG. 7 is a flowchart illustrating an operation method of the hadoop-based multimedia transcoding system of FIG. 1.

### DETAILED DESCRIPTION

The present inventive concept now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

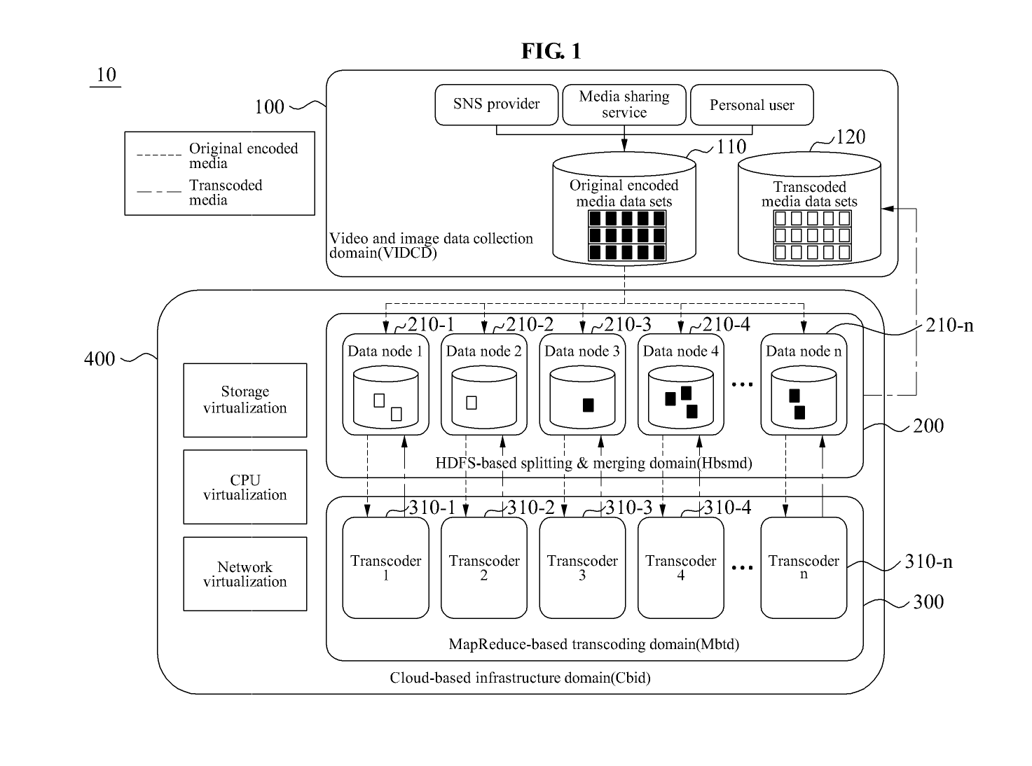

FIG. 1 is a diagram illustrating a hadoop-based multimedia transcoding system 10 according to an embodiment of the present invention.

Referring to FIG. 1, the hadoop-based multimedia transcoding system 10 may include a video and image data collection domain (VIDCD) 100, a hadoop distributed file system (HDFS)-based splitting and merging domain (HbSMD) 200, and a MapReduce-based transcoding domain (MbTD) 300. Additionally, the hadoop-based multimedia transcoding system 10 may further include a cloud-based infrastructure domain (CbID) 400.

The VIDCD 100 may collect original encoded media data sets, and may store the collected original encoded media data sets. For example, the VIDCD 100 may collect the original encoded media data sets, and may store the collected original encoded media data sets in a database 110. The database 110 may include, for example, a local file system. The original encoded media data sets may include, for example, original encoded video files and/or original encoded image files created or produced by media creators, such as social networking service (SNS) providers, media sharing services, and personal users.

The VIDCD 100 may collect original encoded media data sets, based on a data set size and an acquisition time. For example, a period of time required by the VIDCD 100 to collect the original encoded media data sets may be set by administrators and/or users, based on the data set size and the acquisition time.

The VIDCD 100 may receive transcoded media data sets that are created by the HbSMD 200, and may store the transcoded media data sets. For example, the VIDCD 100 may store the transcoded media data sets in a database 120. The database 120 may include, for example, a local file system.

Different databases, for example the databases 110 and 120, are illustrated in FIG. 1, however, the same database may be used according to embodiments. For example, the original encoded media data sets, and the transcoded media data sets may be stored in the same database.

The VIDCD 100 may transmit the transcoded media data sets to heterogeneous mobile devices.

The HbSMD 200 may, using an HDFS, split the original encoded media data sets into first blocks, and automatically distribute the first blocks to a plurality of data nodes 210-1 through 210-n of the HDFS. In FIG. 1, “n” may be a natural number that is greater than “1.” The first blocks may include, for example, data blocks. Each of the plurality of data nodes 210-1 through 210-n may include, for example, a cluster. Each of the plurality of data nodes 210-1 through 210-n may include the HDFS used to store the first blocks.

The HbSMD 200 may distribute the first blocks to at least two data nodes among the plurality of data nodes 210-1 through 210-n, by replicating each of the first blocks. For example, a number of block replicas may be set, and at least one block replica may be obtained. Each of the first blocks may be set to have a default block size. The default block size may be set, for example, to 16 megabytes (MB), 32 MB, 128 MB, 256 MB, and the like, by administrators and/or users.

The HbSMD 200 may split the original encoded media data sets into blocks of a predetermined size, may replicate the blocks, and may store block replicas in an HDFS of each of the plurality of data nodes 210-1 through 210-n. Accordingly, the hadoop-based multimedia transcoding system 10 may be protected from a system failure caused by data loss. For example, stability of data and the hadoop-based multimedia transcoding system 10 may be guaranteed and accordingly, the hadoop-based multimedia transcoding system 10 may simplify and provide fault tolerance, load balancing, and splitting and merging policies.

The HbSMD 200 may merge blocks that are transcoded and transmitted by the MbTD 300, and may generate transcoded media data sets. The transcoded media data sets may include, for example, target transcoded video files and/or target transcoded image files that are suitable for heterogeneous mobile devices. The heterogeneous mobile devices may be implemented, for example, as a laptop computer, a mobile phone, a smart phone, a tablet personal computer (PC), a mobile Internet device (MID), a personal digital assistant (PDA), an enterprise digital assistant (EDA), a digital still camera, a digital video camera, a portable multimedia player (PMP), a personal navigation device or portable navigation device (PND), a handheld game console, or an e-book.

The HbSMD 200 may transmit the transcoded media data sets to the VIDCD 100.

The MbTD 300 may transcode second blocks distributed to the plurality of data nodes 210-1 through 210-n, through distributed and parallel processing, using a MapReduce framework. For example, the MbTD 300 may use Xuggler libraries for video resizing and encoding, as well as, Java advance imaging (JAI) libraries for image resizing and encoding. Additionally, the MbTD 300 may process the second blocks distributed to the plurality of data nodes 210-1 through 210-n, using a map function, in a distributed and parallel manner. The second blocks may include, for example, data blocks.

The MbTD 300 may include a plurality of transcoders 310-1 through 310-n that respectively correspond to the plurality of data nodes 210-1 through 210-n. For example, a single data node, for example a data node 210-1, and a single transcoder, for example a transcoder 310-1, may be located in the same physical device.

Each of the plurality of transcoders 310-1 through 310-n may perform encoding, resizing, and/or decoding, to transcode blocks distributed to each of the plurality of corresponding data nodes 210-1 through 210-n. For example, first, each of the plurality of transcoders 310-1 through 310-n may decode the distributed blocks. When a change in a resolution of a video file and/or an image file included in the original encoded media data sets is required, each of the plurality of transcoders 310-1 through 310-n may perform the resizing to change the resolution. For example, each of the plurality of transcoders 310-1 through 310-n may skip the resizing. Each of the plurality of transcoders 310-1 through 310-n may encode the decoded blocks or resized blocks.

The MbTD 300 may quickly perform distributed and parallel processing on the blocks distributed to each of the plurality of corresponding data nodes 210-1 through 210-n, using each of the plurality of transcoders 310-1 through 310-n based on MapReduce. Accordingly, the hadoop-based multimedia transcoding system 10 may significantly reduce a transcoding processing time.

The CbID 400 may provide infrastructure services in a cloud computing environment via a virtualization technique, for example, a server virtualization technique, a storage virtualization technique, a central processing unit (CPU) virtualization technique, and a network virtualization technique. The CbID 400 may automatically deploy a virtualized cluster environment. Additionally, the CbID 400 may allow a user to select a predetermined configuration of a memory, a CPU, a storage device, and a number of clusters. For example, the CbID 400 may provide a configuration environment of an HDFS and a MapReduce framework.

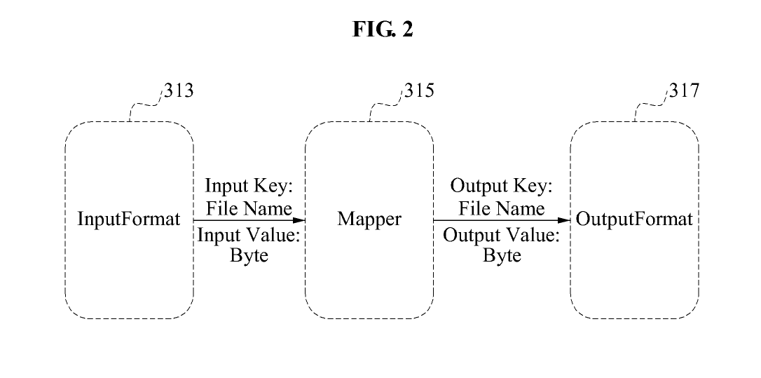

FIG. 2 is a block diagram illustrating a configuration of each of the plurality of transcoders 310-1 through 310-n of FIG. 1.

Referring to FIGS. 1 and 2, each of the plurality of transcoders 310-1 through 310-n may include an InputFormat 313, a mapper 315, and an OutputFormat 317.

The InputFormat 313 may provide information regarding a number of map tasks for the MapReduce framework. For example, the map tasks may be prescheduled in the MapReduce framework.

Additionally, the InputFormat 313 may read blocks distributed to a corresponding data node in a byte stream form, and may generate a line record of an input key/input value pair. The InputFormat 313 may transmit the generated line record of the input key/input value pair to the mapper 315. For example, the input key/input value pair may include a file name, and a single byte stream.

For example, the InputFormat 313 may read blocks from an HDFS of a corresponding data node.

The mapper 315 may process the line record of the input key/input value pair, and may generate a line record of an output key/output value pair. For example, the mapper 315 may perform distributed and parallel processing of the line record of the input key/input value pair, through a map function. Additionally, the line record of the input key/input value pair may be transcoded by Xuggler and JAI media libraries in the mapper 315. The mapper 315 may transmit the generated line record of the output key/output value pair to the OutputFormat 317. For example, the output key/output value pair may include a file name, and a single byte stream.

The OutputFormat 317 may transmit the line record of the output key/output value pair generated by the mapper 315 to a corresponding data node. For example, the OutputFormat 317 may write the line record of the output key/output value pair as a file on an HDFS of the corresponding data node.

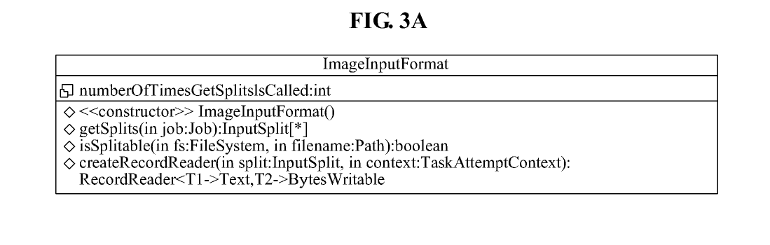

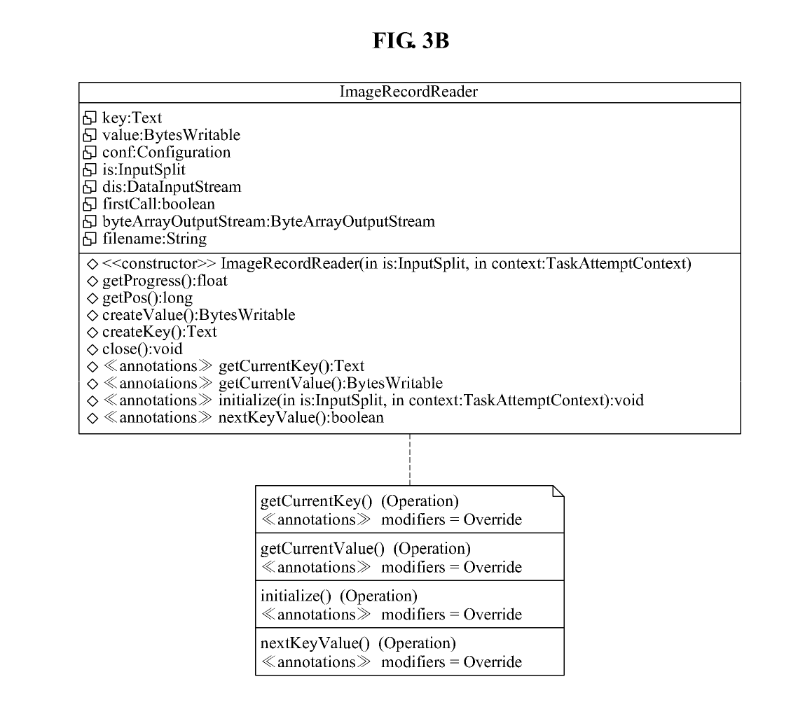

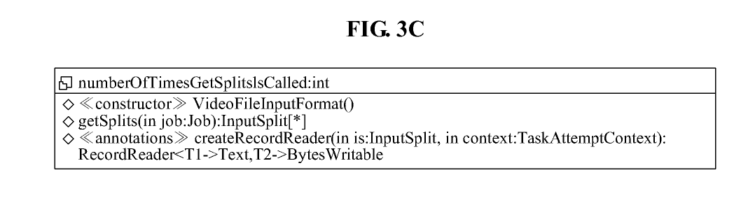

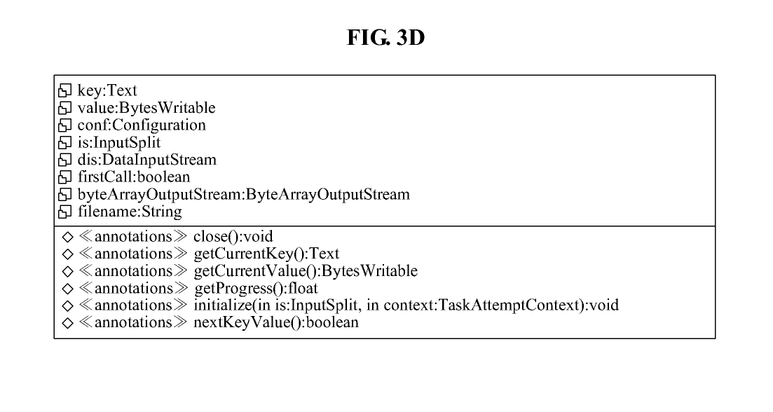

Hereinafter, description will be given of classes for implementing the InputFormat 313, the mapper 315, and the OutputFormat 317 of each of the plurality of transcoders 310-1 through 310-n, to transcode petabyte-scale image data and/or petabyte-scale video data in a parallel and distributed manner, through the MapReduce framework, with reference to FIGS. 3A through 6D.

FIGS. 3A through 3D are diagrams illustrating classes included in the InputFormat 313 of FIG. 2.

Referring to FIGS. 3A through 3D, the InputFormat 313 may include classes ImageInputFormat, ImageRecordReader, VideoFileInputFormat, and VideoRecordReader. For example, the classes ImageInputFormat and ImageRecordReader may be classes for image files, and the classes VideoFileInputFormat and VideoRecordReader may be classes for video files.

The class ImageInputFormat may transform blocks distributed to a corresponding data node, for example image file(s)(*at least one image file, in a byte stream form, and may read the image file(s)(*at least one image file. The class ImageInputFormat may be configured as shown in FIG. 3A.

The class ImageRecordReader may read a single line record transformed as a byte stream from the class ImageInputFormat, and may transmit the read line record to the mapper 315. The single line record may include, for example, a file name and a single byte stream as a key and a value. The class ImageRecordReader may be configured as shown in FIG. 3B.

An operation of each of the classes VideoFileInputFormat and VideoRecordReader may be substantially the same as the above-described operation of each of the classes ImageInputFormat and ImageRecordReader. The classes VideoFileInputFormat and VideoRecordReader may be configured as shown in FIGS. 3C and 3D, respectively.

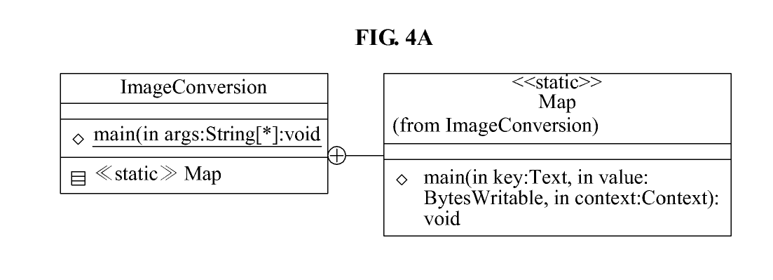

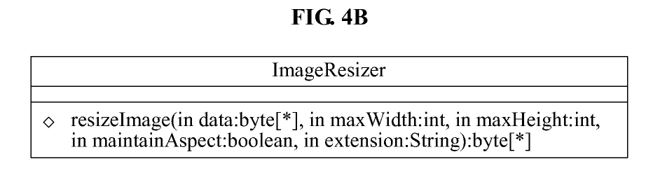

FIGS. 4A and 4B are diagram illustrating classes that are associated with image conversion and that are included in the mapper 315 of FIG. 2.

Referring to FIGS. 4A and 4B, a class ImageResizer may perform transcoding by processing the input key/input value pair, using JAI libraries.

Classes ImageConversion and Map may be configured as shown in FIG. 4A. The class ImageConversion may include a main function, for example “main( ).”

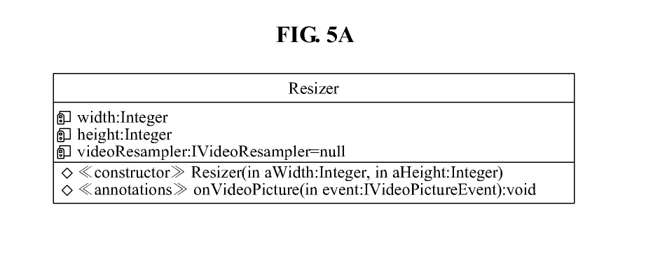

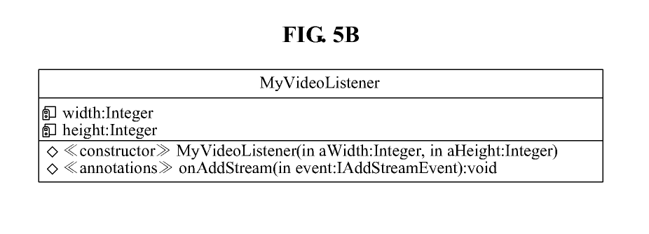

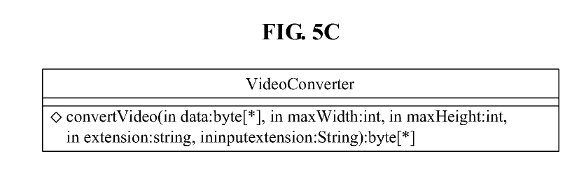

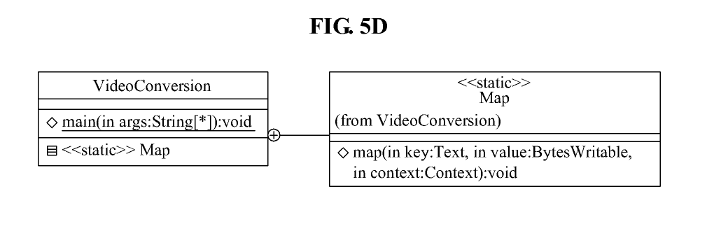

FIGS. 5A through 5D are diagrams illustrating classes that are associated with video conversion and that are included in the mapper 315 of FIG. 2.

Referring to FIGS. 5A through 5C, classes Resizer, MyVideoListener, and VideoConverter may perform video transcoding. For example, the classes Resizer, MyVideoListener, and VideoConverter may be implemented using Xuggler libraries. By using a convertVideo function, for example “convertVideo( )” of the class VideoConverter, the input key/input value pair, for example video data, may be transcoded in a byte stream form based on a file size and a format of video that are set by administrators and users.

Classes VideoConversion and Map may be configured as shown in FIG. 5D.

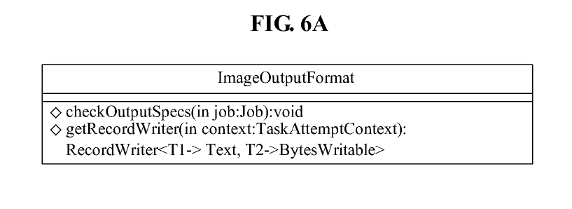

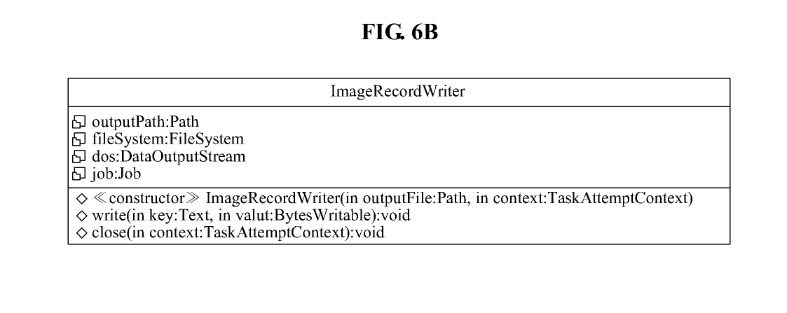

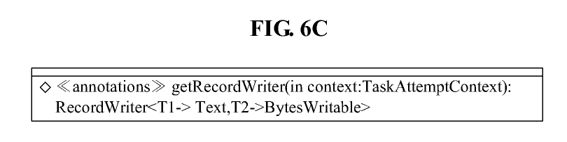

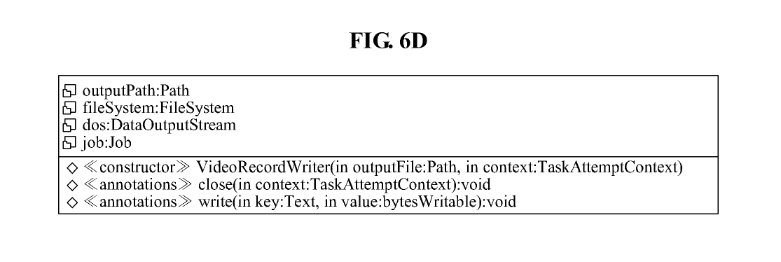

FIGS. 6A through 6D are diagrams illustrating classes included in the OutputFormat 317 of FIG. 2.

Referring to FIGS. 6A through 6D, a class ImageOutputFormat may receive the output key/output value pair generated by the mapper 315 in a record form, for example, as a line record.

A class ImageRecordWriter may write the line record of the output key/output value pair in a specified directory, for example, an HDFS of a corresponding data node.

An operation of each of classes VideoFileOutputFormat and VideoRecordWriter may be substantially the same as the above-described operation of each of the classes ImageOutputFormat and ImageRecordWriter. The classes VideoFileOutputFormat and VideoRecordWriter may be configured as shown in FIGS. 6C and 6D, respectively.

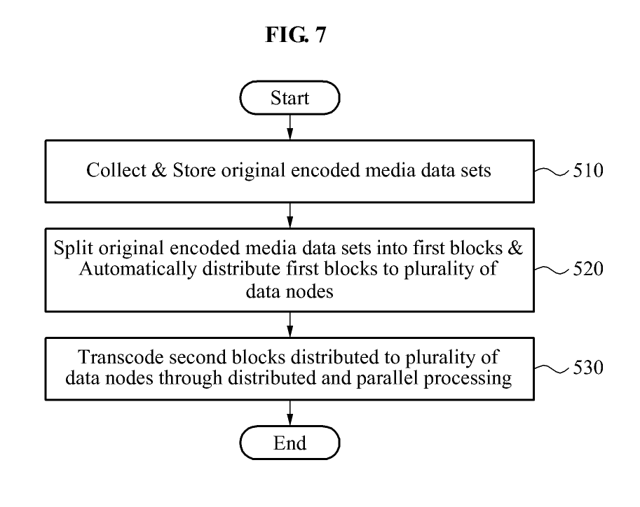

FIG. 7 is a flowchart illustrating an operation method of the hadoop-based multimedia transcoding system 10 of FIG. 1.

Referring to FIG. 7, in operation 510, the VIDCD 100 may collect the original encoded media data sets and may store the collected original encoded media data sets.

In operation 520, the HbSMD 200 may split the original encoded media data sets into first blocks, and may automatically distribute the first blocks to the plurality of data nodes 210-1 through 210-n.

In operation 530, the MbTD 300 may transcode second blocks distributed to the plurality of data nodes 210-1 through 210-n, through distributed and parallel processing.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A hadoop-based multimedia transcoding system, comprising:
a video and image data collection domain (VIDCD) to collect original encoded media data sets, and to store the collected original encoded media data sets;
a hadoop distributed file system (HDFS)-based splitting and merging domain (HbSMD) to split the original encoded media data sets into first blocks, and to automatically distribute the first blocks to a plurality of data nodes of an HDFS, by using the HDFS; and
a MapReduce-based transcoding domain (MbTD) to transcode second blocks distributed to the plurality of data nodes, through distributed and parallel processing, using a MapReduce framework.

2. The hadoop-based multimedia transcoding system of claim 1, wherein the HbSMD merges blocks that are transcoded and transmitted by the MbTD, and generates transcoded media data sets.

3. The hadoop-based multimedia transcoding system of claim 1, wherein the HbSMD distributes each of the first blocks to at least two data nodes among the plurality of data nodes, by replicating each of the first blocks.

4. The hadoop-based multimedia transcoding system of claim 1, wherein the MbTD comprises a plurality of transcoders respectively corresponding to the plurality of data nodes,
wherein each of the plurality of transcoders comprises:
an InputFormat to read blocks distributed to a corresponding data node in a byte stream form, and to generate a line record of an input key/input value pair;
a mapper to process the line record of the input key/input value pair, and to generate a line record of an output key/output value pair; and
an OutputFormat to transmit the line record of the output key/output value pair to the corresponding data node.

5. The hadoop-based multimedia transcoding system of claim 1, wherein each of the first blocks is set to have a default block size.

6. The hadoop-based multimedia transcoding system of claim 3, wherein setting of a number of block replicas obtained by replicating each of the first blocks is enabled.

7. The hadoop-based multimedia transcoding system of claim 1, further comprising:
a cloud-based infrastructure domain (CbID) to provide a configuration environment of the HDFS and the MapReduce framework.

8. The hadoop-based multimedia transcoding system of claim 1, wherein the VIDCD collects the original encoded media data sets, based on a data set size and an acquisition time.

9. The hadoop-based multimedia transcoding system of claim 4, wherein each of the input key/input value pair and the output key/output value pair comprises a file name and a single byte stream.

10. The hadoop-based multimedia transcoding system of claim 4, wherein the InputFormat provides information regarding a number of map tasks for the MapReduce framework.

11. The hadoop-based multimedia transcoding system of claim 10, wherein the map tasks are prescheduled in the MapReduce framework.

12. The hadoop-based multimedia transcoding system of claim 4, wherein the mapper performs distributed and parallel processing of the line record of the input key/input value pair, through a map function.

13. A multimedia transcoding method, comprising:
collecting original encoded media data sets, and storing the collected original encoded media data sets;
splitting the original encoded media data sets into first blocks, and automatically distributing the first blocks to a plurality of data nodes; and
transcoding second blocks distributed to the plurality of data nodes, through distributed and parallel processing.

14. The multimedia transcoding method of claim 13, further comprising:
merging transcoded blocks, and generating transcoded media data sets corresponding to the original encoded media data sets.

15. The multimedia transcoding method of claim 13, wherein the splitting comprises distributing each of the first blocks to at least two data nodes among the plurality of data nodes, by replicating each of the first blocks.

16. The multimedia transcoding method of claim 13, wherein the transcoding comprises:
reading blocks distributed to the plurality of data nodes in a byte stream form, and generating a line record of an input key/input value pair;
processing the line record of the input key/input value pair, and generating a line record of an output key/output value pair; and
transmitting the line record of the output key/output value pair.

17. The multimedia transcoding method of claim 16, wherein the processing comprises performing distributed and parallel processing of the line record of the input key/input value pair, through a map function.

18. A non-transitory computer readable recording medium storing a program to cause a computer to implement the method of claim 13.
